(19) United States
(12) Patent Application Publication
(10) Pub. No.: US 2007/0281146 A1
(43) Pub. Date: Dec. 6, 2007

(54) Porous, heat-insulating shaped body, method for producing the shaped body and the use thereof

(75) Inventors: Dorothee Burkhard, Waldbronn (DE); Rolf Nuesch, Karlsruhe (DE)

Correspondence Address: VENABLE LLP, P.O. BOX 34385, WASHINGTON, DC, 20043-9998, US

(73) Assignee: Forschungszentrum Karlsruhe GmbH, Karlsruhe (DE)

(21) Appl. No.: 11/443,468

(22) Filed: May 31, 2006

(51) Int. Cl. B32B 3/26

(52) U.S. Cl. 428/305.5; 428/312.6

(57) ABSTRACT

A porous, heat-insulating shaped body, obtained by tempering a material mixture having a weight ratio of 1:1, wherein the mixture includes a silicate such as, for example, natural or expanded perlite, natural or furnace slag pumice, expanding clay, or expanding glass, and an inorganic component selected such that the melting point for the mixture of silicate and inorganic component is in the range of a sintering temperature of the silicate and that a gas is furthermore released from the inorganic component in this temperature range. The porous, heat-insulating shaped body functions to control moisture when used in the form of a heat-insulating board or in the form of an admixture for building materials.

### CROSS-REFERENCE TO RELATED APPLICATIONS

The present application is based on European Patent Application No. 05001881.1, filed Jan. 29, 2005, which was published on Aug. 10, 2005 as European Patent Application Publication No. EP 1 561 739 A2, the subject matter of which is incorporated herein by reference.

### BACKGROUND OF THE INVENTION

1. Field of the Invention

The invention relates to a porous, heat-insulating shaped body, a method for producing said shaped body, and the use thereof.

2. Related Art

Heat-insulating materials in the form of boards (heat-insulating boards) or in the form of bulk filler materials have long been available and in use in the building sector. Mineral insulating materials, for example, silicate-based materials such as natural and expanded perlite, vermiculite, natural and furnace slag pumice, expanding clay and expanding glass, are fire-resistant materials which are generally also resistant to chemicals and are environmentally-friendly.

Of particular interest in this connection is the volcanic glass-rock material perlite (natural or crude perlite), which can expand as a result of abrupt heating to above 1000° C. Expanded perlite has an extremely low thermal conductivity of 0.045 W/m·K and is therefore used as grainy filler (bulk debris) for cavities in facade insulation materials or as balancing filler underneath dry finishing plaster.

Pressed perlite boards are used in particular for flat roofs or parking decks, wherein these boards have a considerably lower heat insulation effect than the bulk filler materials. German patent document DE 197 12 835 A1 discloses the production of shaped bodies molded from lightweight aggregates such as perlite and vermiculite which, together with an alkali silicate as a bonding agent, are produced through sintering at a temperature between 400° C. and 1000° C. European patent document EP 0 475 302 A1 discloses a method for producing pressed perlite boards, containing an admixture of sodium silicate binder, at a pressure ranging from 2.07 to 35.49 bar and a temperature between 65 and 204° C.

A fire-resistant heat-insulating material of vermiculite or perlite is known from German patent document DE 199 23 144 A1, wherein this material contains an admixture of 5-30% of micro hollow spheres (aerogels). German patent document DE 198 09 590 A1 describes fire-resistant shaped bodies, composed of meta kaolin, silicon dioxide, alkali silicate (liquid glass) as well as 30-70 weight % of perlite or vermiculite.

Finally, German patent document DE 198 41 054 A1 discloses cellular roof tiles with air chambers that are filled with a dry thin bed mortar containing perlite, vermiculite, or pumice as lightweight admixture to increase the heat insulation.

### SUMMARY OF THE INVENTION

It is an object of the present invention to propose a porous, heat-insulating formed body which is composed of inorganic components, as well as a method for producing said formed body and its use.

According to one exemplary embodiment of the invention there is provided a porous, heat-insulating formed body that comprises a tempered product of a mixture of silicate and an inorganic component in a 1:1 weight ratio. The silicate used is one of the natural silicates (glass or mineral), natural or expanded perlite, natural or furnace slag pumice, expanding clay or expanding glass.

The inorganic component selected is one that releases a gas in the range of the sintering or melting temperature for the selected silicate. Carbonates or inorganic nitrogen compounds such as nitrides, nitrites, and nitrates are especially suitable for use, while sulfur compounds, for example, are less suitable because they are less friendly to the environment and/or have toxic properties.

The invention is based on the idea of producing a porous silicate glass, having a density in the range of about 0.4 to about 0.9 g/cm³, by adding the inorganic component to the silicate through the process of purposely melting it on. The tempered product according to the invention consists of a porous silicate with a multi-modal pore distribution in the μm and mm range.

According to another exemplary embodiment, a mixture of natural or expanded perlite and sodium carbonate Na₂CO₃ forms the basis for the tempered product according to the invention. In principle, any type of silicate can be used for producing a formed body according to the invention, provided a suitable carbonate or a suitable nitrogen compound is available for the silicate.

To produce a porous, heat-insulating formed body, the silicate is provided in method step a) and is mixed in method step b) with a suitable inorganic component, preferably carbonate, in a 1:1 weight ratio. In general, this component must be selected such that the melting point of the mixture comprising the silicate and the inorganic component is in the range of the sintering temperature for the silicate, and that the component releases a gas in this temperature range. In method step c), the mixture is heated up quickly within a short time to the melting point for this mixture, thereby allowing a gas, carbon dioxide CO₂ in the case of a carbonate, to escape in part, which renders the silicate melt porous. The porous, heat-insulating formed body produced in this manner is cooled and removed in method step d).

With this method, any other temperature at which the silicate component experiences a reaction, for example de-watering, can furthermore be used in place of the sintering temperature.

The silicate component is combined with an expanding material that releases gas at a temperature which is preferably in the range of the melting temperature of the mixture comprising silicate and the inorganic component of expanding material. This takes into consideration the fact that mixing together the two components of silicate and the expanding material will lower the melting point. If too much carbon dioxide escapes, the melting point for the mixture will be higher.

According to one exemplary embodiment, natural or expanded perlite is selected for producing a porous, heat-insulating formed body on a mineral base. Expanded perlite is a highly porous granular bulk material which does not have inherent dimensional stability. However, as a mineral raw material it is already fire-resistant and for the most part also resistant to chemicals.

If the mixture comprises expanded perlite and sodium carbonate, the tempering takes place at a temperature from about 800° C. to about 820° C. With a mixture comprising natural perlite and sodium carbonate, the tempering is effected at a temperature from about 840° C. to about 860° C. In the use of natural perlite, it is particularly advantageous to heat the mixture to above about 1000° C. and expand it.

In this exemplary embodiment, a porous, heat-insulating formed body is formed that has a surprisingly low density and simultaneously also controls moisture. It was observed that, during the cooling down of the tempered product, a new component with moisture-control characteristics was precipitated out, namely sodium zeolite. Sodium zeolites make it possible to produce a porous, heat-insulating formed body capable of moisture control, using only a single production step, wherein the sodium zeolite blooms during the cooling of the pore cavities.

Growing sodium zeolite crystals are particularly suitable for controlling moisture. Owing to their large internal surface of 50-1000 m²/g, sodium zeolites can reversibly incorporate moisture from the steam phase. In other words, sodium zeolites can adsorb as well as desorb moisture.

Experimental tests on sorption behavior have indicated that, in the porous, heat-insulating formed bodies according to the invention, no hysteresis occurs during the adsorption and desorption of moisture from the environment. Instead, the moisture is virtually completely re-released (desorption). With respect to the total weight of the formed body, the weight increases or decreases by 200% with a variation in the air humidity between 40 and 98%.

The many mineral-based heat-insulating materials which are presently available do not control moisture, and lose a great deal of their heat-insulating capacity during the adsorption of moisture. The availability of a material with the additional characteristic of controlling moisture therefore has considerable advantages for the building industry.

In addition to the heat-insulating characteristic, the exemplary embodiment of the porous, heat-insulating formed body that is composed of perlite and sodium carbonate also has the characteristic of controlling moisture in the ambient air, thereby making it particularly suitable for specifically removing building moisture, for preventing the growth of mold, or for simply creating a comfortable room and living climate. Whereas the heat-insulating capacity in traditional heat-insulating materials decreases with increasing humidity in the air, the heat-insulating capacity of the formed body according to the invention is separated from the degree of moisture, since the thermal bridges are not identical to the moisture-control material (sodium zeolite).

The formed bodies according to the invention can thus be used as heat-insulating materials in the form of heat-insulating boards and, in particular, as heat-insulating materials with moisture control in the form of insulating boards with moisture control characteristics, or they can be comminuted and added to building materials such as plaster. In general, the formed bodies according to the invention or the granular products therefrom can be used as building materials or auxiliary building materials.

### BRIEF DESCRIPTION OF THE DRAWINGS

The invention is explained in further detail in the following with the aid of exemplary embodiments, showing in:

FIG. 1 A differential thermo-analysis (differential scanning calorimetry DSC) of expanded perlite in air. The heating rate was 20 K/min while the exothermic sintering process started at approximately 700° C.

FIG. 2 A differential thermo-analysis (DSC) of a mixture of expanded perlite in air and sodium carbonate, in a weight ratio of 1:1. The heating rate was 20 K/min while the endothermic peak of approximately 850° C. was near the melting temperature of the carbonate (852° C.).

FIG. 3 Image of a hardened, dimensionally stable perlite material, produced with the method according to the invention.

FIG. 4 Magnified images showing pores in the tempered product of expanded perlite and sodium carbonate in the mm range. Scale: 1000 μm and 500 μm.

FIG. 5 Images obtained with the ESEM (environmental scanning electron microscope) of the porous structure of the tempered product, composed of expanding perlite and sodium carbonate, in a multi-modal distribution in the μm range. The right image shows the sodium zeolites that bloomed during the cooling down period and function to control the moisture.

FIG. 6 The isothermal sorption behavior of a sample comprising expanded perlite and sodium carbonate, obtained through the dynamic steam sorption method (DVS).

### DETAILED DESCRIPTION OF THE INVENTION

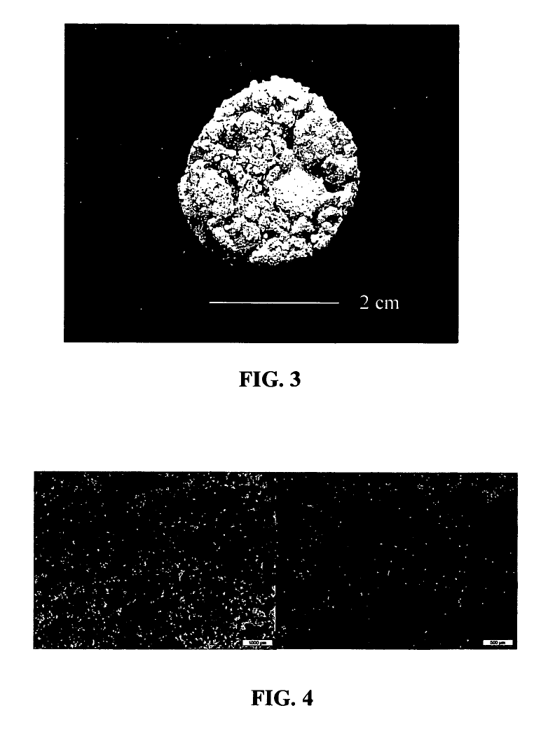

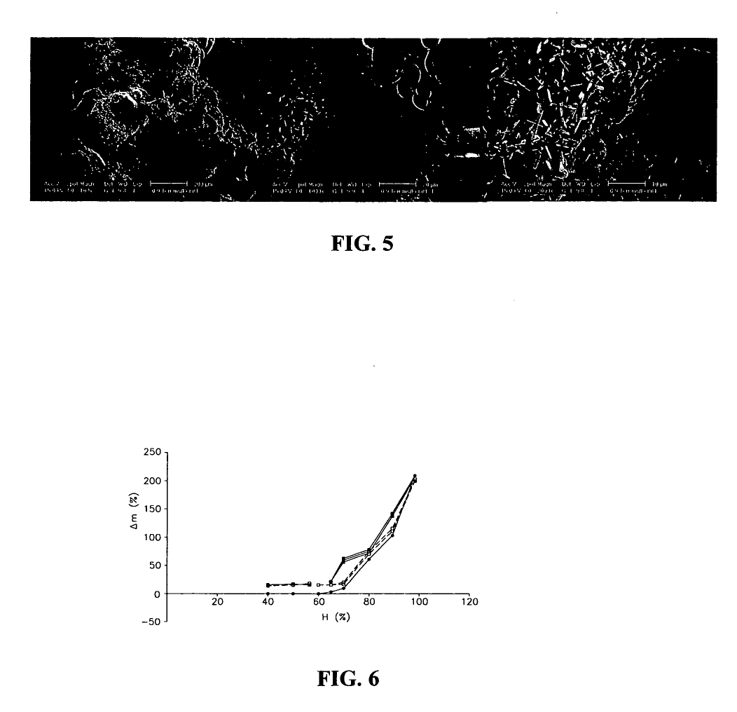

In a first embodiment, 2 g of expanded perlite and 2 g of sodium carbonate Na₂CO₃ are mixed together in a weight ratio of 1:1. The mixture is then tempered for 15 minutes at about 800° C. inside a cylindrical crucible in a chamber furnace. Depending on the quantity used, the duration of the tempering process is about 10 to 20 minutes. A dimensionally stable cylinder (FIG. 3) with pores in the micrometer range (FIG. 4) is thus obtained, in which sodium zeolite blooms (FIG. 5). Deviations by up to ±5 percent from the starting weight ratio are not important for the final result.

In a second embodiment, 2 g of natural perlite are mixed with 2 g of sodium carbonate Na₂CO₃ in a 1:1 weight ratio and tempered in a chamber furnace at about 850° C. for 20 minutes. Depending on the quantity used, the duration of the tempering process is about 15 to 30 minutes.

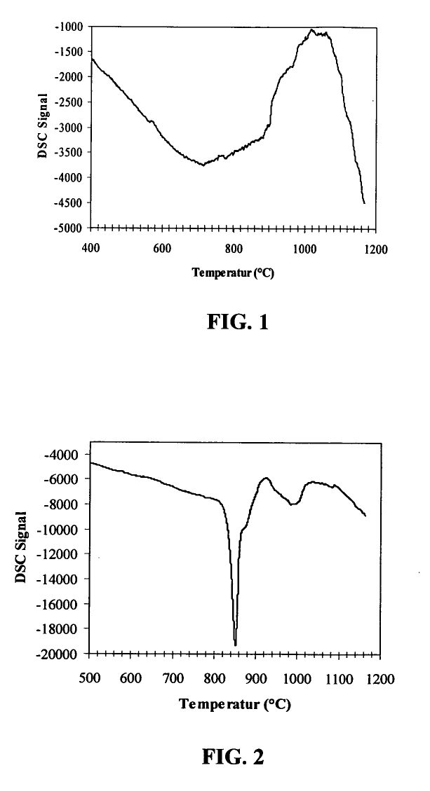

The DSC graph (differential scanning calorimetry) in FIG. 1 shows that expanded perlite begins to sinter at approximately 700° C., while sodium carbonate Na₂CO₃ has a melting point of 852° C. A DSC analysis of a mixture of Na₂CO₃ and expanded perlite, in a weight ratio of 1:1, shows that the mixture begins to melt at approximately 800° C. and that the endothermic melting peak practically coincides with that of the Na₂CO₃ (852° C.). Sodium zeolite, which can control moisture, is precipitated out during the cooling period. Since the moisture is controlled by the sodium zeolites and not the glass, the heat-insulating capacity is not reduced by the moisture which may be present.

Owing to the lowering of the melting point, the mixture of expanded perlite and Na₂CO₃ begins to melt at a temperature of about 800° C. during the tempering, wherein two glass components with different sodium contents are formed in the process. An EDS analysis showed that the original perlite material was melted on and that two mixed melts with different sodium contents formed. During the melting on, CO₂ is released in part, which results in the formation of pores in the range of a few μm to several mm because of the relatively high viscosity of the silicate glass.

The formed body produced according to the invention has an approximate density of 0.5 g/cm³, while its material density is approximately 2.1 g/cm³. The resistance to pressure of this material is higher than 1500 kN/m². ESEM images (FIG. 5) show that the sodium zeolites, which bloom on the surface of the material, are known for their good moisture adsorption and desorption. If the formed body is placed in water, the sodium zeolites are leached out after only 5 minutes. The heat-insulating material itself remains undamaged, even after three weeks in water.

The isothermal sorption behavior of a sample made of expanded perlite and sodium carbonate was tested with the dynamic steam sorption method (DVS, Differential Vapor Sorption). After equilibrium was established at 0% humidity, the humidity was incrementally increased. FIG. 6 illustrates measurements taken between −40 and 98% air humidity for three cycles. Here, H (%) represents the humidity as a percentage, and Δm (%) represents the increase or decrease, respectively, of the mass relative to the dried sample, for which Δm (%)=0%.

FIG. 6 depicts an increase in weight by 200% relative to the total weight of the sample (insulating material) because of water adsorption. Desorption occurs virtually without hysteresis, and the water is completely re-released. The zeolites on the surface of the glass, as shown in FIG. 5, for example, are responsible for this sorption behavior. Although a small proportion of about 14% remains bound in the zeolite structure following the first cycle, it has no detrimental effect on the sorption behavior of subsequent cycles.

The invention has been disclosed in conjunction with various exemplary embodiments thereof, and a number of modifications and variations have been discussed. Other modifications and variations will readily suggest themselves to persons of ordinary skill in the art. The invention is intended to embrace these and all other modifications and variations that fall within the spirit and broad scope of the appended claims.

1. A method for producing a porous, heat-insulating shaped body, comprising:
providing a silicate selected from the group consisting of natural perlite, expanded perlite, natural slag pumice, furnace slag pumice, expanding clay, and expanding glass;
mixing the silicate with an inorganic component in a weight ratio of 1:1, wherein the inorganic component is selected such that the melting point of the mixture of the silicate and the inorganic component is in a range of a sintering temperature of the silicate and the inorganic component is adapted to release a gas in this temperature range;
tempering the mixture at a temperature in the range of the silicate sintering temperature to form a silicate melt, whereby a gas is at least partially released from the inorganic component and penetrates the silicate melt to create pores; and
cooling and removing the porous, heat-insulating shaped body.

2. The method for producing a porous, heat-insulating shaped body according to claim 1, wherein the inorganic component comprises a carbonate or a mixture of different carbonates.

3. The method for producing a porous, heat-insulating shaped body according to claim 1, wherein the silicate comprises a natural or expanded perlite and the inorganic component comprises sodium carbonate.

4. The method for producing a porous, heat-insulating shaped body according to claim 3, wherein a mixture composed of expanded perlite and sodium carbonate is tempered at a temperature between about 800° C. and about 820° C.

5. The method for producing a porous, heat-insulating shaped body according to claim 3, wherein a mixture composed of natural perlite and sodium carbonate is tempered at a temperature between about 840° C. and about 860° C.

6. A porous, heat-insulating shaped body, obtained according to a method comprising:
providing a silicate selected from the group consisting of natural perlite, expanded perlite, natural slag pumice, furnace slag pumice, expanding clay, and expanding glass;
mixing the silicate with an inorganic component in a weight ratio of 1:1, wherein the inorganic component is selected such that the melting point of the mixture of the silicate and the inorganic component is in a range of a sintering temperature of the silicate and the inorganic component is adapted to release a gas in this temperature range;
tempering the mixture at a temperature in the range of the silicate sintering temperature to form a silicate melt, whereby a gas is at least partially released from the inorganic component and penetrates the silicate melt to create pores; and
cooling and removing the porous, heat-insulating shaped body.

7. The porous, heat-insulating shaped body according to claim 6, wherein sodium zeolites are present in the pores.

8. The porous, heat-insulating shaped body according to claim 6, wherein the body has a density in a range from about 0.4 g/cm³ to about 0.9 g/cm³.

9. A method for controlling moisture, comprising: utilizing the porous, heat-insulating shaped body according to claim 6.

10. The method according to claim 9, wherein the utilizing step includes forming the porous, heat-insulating shaped body into a heat-insulating board.

11. The method according to claim 9, wherein the utilizing step includes admixing the porous, heat insulating body in building materials.

12. A porous, heat-insulating shaped body, comprising a tempered mixture of a 1:1 weight ratio of (1) a silicate selected from the group consisting of natural or expanded perlite, natural or furnace slag pumice, expanding clay, and expanding glass, and (2) an inorganic component selected such that the melting point for the mixture composed of the silicate and the inorganic component is in a range of a sintering temperature for the silicate and that the inorganic component releases a gas in the range of the silicate sintering temperature.

13. The porous, heat-insulating shaped body according to claim 12, wherein the inorganic mixture is selected from a carbonate or a mixture of carbonates.

14. The porous, heat-insulating shaped body according to claim 13, wherein the silicate comprises a natural or expanded perlite and the inorganic component comprises a sodium carbonate.

15. The porous, heat-insulating shaped body according to claim 14, further including sodium zeolites disposed in the pores of the body.

16. The porous, heat-insulating shaped body according to claim 12, wherein the body has a density in a range from about 0.4 g/cm³ to about 0.9 g/cm³.

17. A method for controlling moisture, comprising: utilizing the porous, heat-insulating shaped body according to claim 12.

18. The method according to claim 17, wherein the utilizing step includes forming the porous, heat-insulating shaped body into a heat-insulating board.

19. The method according to claim 12, wherein the utilizing step includes admixing the porous, heat insulating body in building materials.
